(19) United States
(12) Patent Application Publication
(10) Pub. No.: US 2025/0062447 A1
(43) Pub. Date: Feb. 20, 2025

(54) ENCLOSURE FOR BATTERY CELLS

(71) Applicant: GM GLOBAL TECHNOLOGY OPERATIONS LLC, Detroit, MI (US)

(72) Inventors: Diptak BHATTACHARYA, Royal Oak, MI (US); Anil K. SACHDEV, Rochester Hills, MI (US); Seung-Woo CHU, Clawson, MI (US); Mark W. VERBRUGGE, Sonoma, CA (US); Ryan Patrick HICKEY, Austin, TX (US)

(21) Appl. No.: 18/449,006

(22) Filed: Aug. 14, 2023

(51) Int. Cl. H01M 50/103; H01M 10/613; H01M 10/647; H01M 10/653; H01M 10/658; H01M 50/119; H01M 50/166; H01M 50/169; H01M 50/176; H01M 50/209; H01M 50/548

(52) U.S. Cl. CPC H01M 50/103; H01M 10/613; H01M 10/647; H01M 10/653; H01M 10/658; H01M 50/119; H01M 50/166; H01M 50/169; H01M 50/176; H01M 50/209; H01M 50/548

(57) ABSTRACT

A battery cell including a can body of an enclosure comprising a sheet of metal that is folded into an open cylindrical shape and welded. The can body includes a first opening and a second opening at opposite ends of the can body. The can body is configured to receive a battery cell stack. A lid portion of the enclosure is attached to the first opening of the can body. A bottom portion of the enclosure is attached to the second opening of the can body.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to battery cells, and more particularly to an enclosure for prismatic or cylindrical battery cells.

Electric vehicles (EVs) such as battery electric vehicles (BEVs), hybrid vehicles, and/or fuel cell vehicles include one or more electric machines and a battery system including one or more battery cells, modules, and/or packs. A power control system is used to control charging and/or discharging of the battery system during charging and/or driving.

### SUMMARY

A battery cell including a can body of an enclosure comprising a sheet of metal that is folded into an open cylindrical shape and welded. The can body includes a first opening and a second opening at opposite ends of the can body. The can body is configured to receive a battery cell stack. A lid portion of the enclosure is attached to the first opening of the can body. A bottom portion of the enclosure is attached to the second opening of the can body.

In other features, the battery cell stack includes A anode electrodes, C cathode electrodes, and S separators, where A, C, and S are integers greater than one.

In other features, a first side of the enclosure includes a plurality of stiffening portions arranged in a first pattern. A second side of the enclosure opposite to the first side of the enclosure includes a plurality of stiffening portions arranged in a second pattern. The first pattern and the second pattern are different.

In other features, the first pattern and the second pattern are offset to allow nesting of the battery cell with one or more adjacent battery cells. The plurality of stiffening portions comprise at least one of dimples and stiffening beads. The dimples have one of a rectangular cross section and an arcuate cross section.

In other features, one of the lid portion and the bottom portion includes a first terminal and a second terminal connected to external tabs of the A anode electrodes and the C cathode electrodes, respectively. At least one of the lid portion and the bottom portion includes a vent.

In other features, the lid portion includes a first terminal connected to external tabs of the A anode electrodes. The bottom portion includes a second terminal connected to external tabs of the C cathode electrodes. At least one of the lid portion and the bottom portion includes a vent.

In other features, a side of the enclosure includes a stiffening bead extending outwardly therefrom and a measuring device arranged in a volume created by the stiffening bead. The first pattern includes a first region and a second region. The plurality of stiffening portions are arranged in the first region and not in the second region, wherein the second region is hotter than the first region during a battery thermal event.

In other features, edges of the sheet of metal are welded together along a non-stressed side of the can body. The bottom portion is attached to the can body using one of welding and mechanical joining. The lid portion is attached to the can body using one of welding and mechanical joining. At least one of the bottom portion and the lid portion include micro dimples. A volume created by the plurality of stiffening portions is filled with a one of an insulating material and a thermal interface material.

A system includes a plurality of the battery cells and a cooling plate. A thermal interface material is arranged between the cooling plate and a first one of the plurality of the battery cells and a second one of the plurality of the battery cells.

A system includes a plurality of the battery cells. An insulating material is arranged between adjacent ones of the plurality of the battery cells.

A method for manufacturing a battery cell includes using first and second rollers to create a first pattern of stiffening portions and a second pattern of stiffening portions on a sheet of metal and folding the sheet of metal into an open cylindrical shape to form a can body of an enclosure. The first pattern of stiffening portions is located on one side of the enclosure and the second pattern of stiffening portions is located on another side of the enclosure. The method includes welding a non-stressed side of the enclosure; attaching a lid portion to a first opening of the can body; and attaching a bottom portion to a second opening of the can body.

In other features, the first pattern of stiffening portions comprise at least one of dimples and stiffening beads. The first pattern of stiffening portions and the second pattern of stiffening portions are different. The first pattern of stiffening portions and the second pattern of stiffening portions are offset to allow nesting of the battery cell with one or more adjacent battery cells.

In other features, attaching the lid portion to the first opening of the enclosure using at least one of mechanical joining and welding; and attaching the bottom portion to the second opening of the enclosure using at least one of mechanical joining and welding.

In other features, one of the lid portion and the bottom portion includes a first terminal and a second terminal connected to external tabs of A anode electrodes and C cathode electrodes of a battery stack, respectively and at least one of the lid portion and the bottom portion includes a vent; or the lid portion includes a first terminal connected to external tabs of one of the A anode electrodes and the C cathode electrodes, the bottom portion includes a second terminal connected to external tabs of the other of the A anode electrodes and the C cathode electrodes, and at least one of the lid portion and the bottom portion includes a vent.

Further areas of applicability of the present disclosure will become apparent from the detailed description, the claims, and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a side cross sectional view of an example of a battery cell including cathode electrodes, anode electrodes, and separators arranged in a battery cell enclosure according to the present disclosure;

FIG. 2A is a perspective view of an example of a battery cell;

FIG. 2B is a perspective view of an example of a battery cell with a pressure-based vent cap;

FIGS. 3A to 3F are perspective views of examples of enclosures for battery cells with stiffening portions according to the present disclosure;

FIG. 4A is a perspective view illustrating an example of a method for manufacturing the enclosures for a battery cell according to the present disclosure;

FIG. 4B is a plan view illustrating the example of a method for manufacturing the battery cell according to the present disclosure;

FIGS. 5A to 5E are perspective and side views illustrating an example of a nesting of the battery cells with stiffening beads according to the present disclosure;

FIGS. 6A to 6C are perspective and side views illustrating nesting of the battery cell with stiffening dimples according to the present disclosure;

FIG. 7 is a perspective view of an enclosure for a battery cell with a side surface including a first region with stiffening portions and second region without stiffening portions according to the present disclosure;

FIGS. 8 and 9 are perspective views of battery cells with a stiffening bead on a non-stressed side and a measuring device such as a reference electrode or thermocouple arranged therein according to the present disclosure;

FIGS. 10A to 10F are perspective and side cross sectional views of a can body that is welded and a lid portion and a bottom portion that are mechanically joined according to the present disclosure;

FIGS. 11 and 12 are perspective views of enclosures for battery cells including a vent and terminals arranged on opposite sides or the same side, respectively, according to the present disclosure;

FIGS. 13 and 14 are perspective views of examples of a plurality of battery cells arranged on a thermal interface material and a cooling plate according to the present disclosure;

FIGS. 15 and 16 illustrate examples of an interface between the thermal interface material and the cooling plate according to the present disclosure; and

FIGS. 17 and 18 are perspective views of examples of a plurality of battery cells and a thermal interface material and a cooling plate according to the present disclosure.

In the drawings, reference numbers may be reused to identify similar and/or identical elements.

### DETAILED DESCRIPTION

While battery cells according to the present disclosure are shown in the context of electric vehicles, the battery cells can be used in stationary applications and/or other applications.

Battery cells include a battery stack arranged in a battery enclosure. The battery enclosures may have form factor restrictions when manufactured using impact extrusion, stamping, and/or drawing methods. These manufacturing methods may also limit locations for battery terminals on the battery enclosure. The battery enclosure needs to have sufficient strength to be able to handle swelling of the battery stack during cycling of the battery cell. The battery enclosure also needs to handle high temperatures during thermal events that may cause significant heating and/or melting of the battery enclosure.

The present disclosure relates to a method for manufacturing a battery enclosure for prismatic or cylindrical battery cells. The battery enclosure includes a can body and a lid portion, and a bottom portion.

In some examples, the can body of the battery enclosure is made from sheet metal. Using the manufacturing methods described below, the battery enclosure may be manufactured in any form factor without restriction on length, width, or height. In some examples, stiffening portions such as beads or dimples are formed in a metal sheet to increase stiffness and/or to resist outward bowing of the can body due to internal pressure in the battery cell during operation. For example, the pressure in the battery cell enclosure increases due to pressure build-up as the electrodes expand during cycling and/or due to buildup of vent gases caused by thermal events such as thermal runaway.

In some examples, the can body is made of steel, which has higher strength and stiffness than aluminum. The melting point of steel is greater than the expected temperature of the burning gases in the battery enclosure during thermal runaway. Steel battery enclosures can also be made using thinner walls as compared to aluminum, which saves space and leads to an overall shorter battery pack. In some examples, the battery enclosure includes a stiffening bead on a non-stressed, narrow face of the battery enclosure. The inner volume of the stiffening bead houses a device such as a sensor, a reference electrode, a thermocouple, or other sensor.

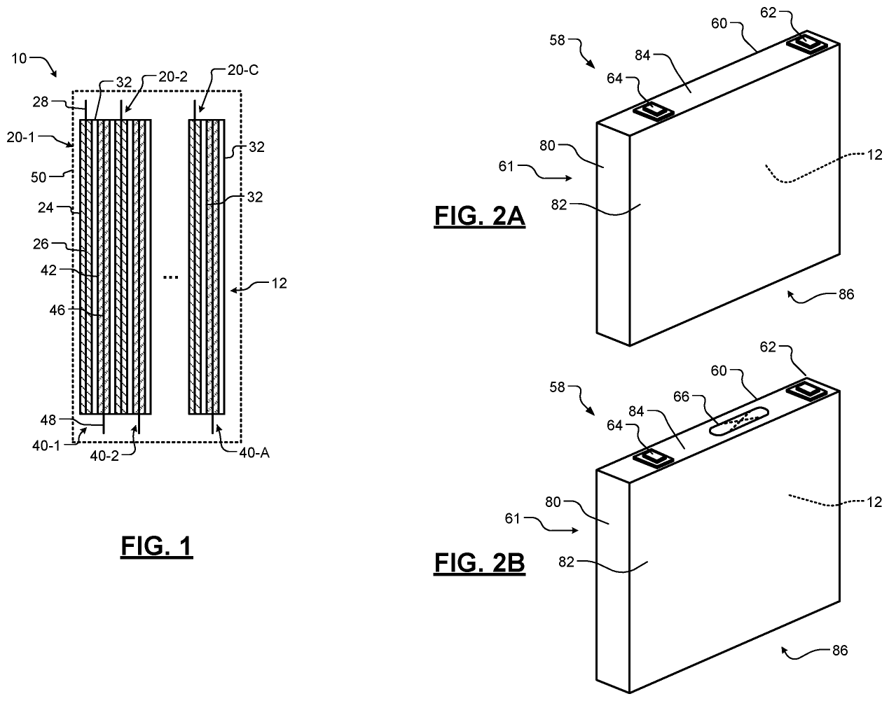

Referring now to FIG. 1, a battery cell 10 includes C cathode electrodes 20, A anode electrodes 40, and S separators 32 arranged in a predetermined sequence in a stack 12 located in an enclosure 50. The C cathode electrodes 20-1, 20-2, . . . , and 20-C (where C is an integer greater than one) include cathode active layers 24 arranged on one or both sides of cathode current collectors 26. The A anode electrodes 40-1, 40-2, . . . , and 40-A (where A is an integer greater than one) include anode active layers 42 arranged on one or both sides of the anode current collectors 46.

In some examples, the anode active layers 42 and/or the cathode active layers 24 are free-standing electrodes that are arranged adjacent to (or attached to) the current collectors. In some examples, the anode active layers 42 and/or the cathode active layers 24 comprise coatings including one or more active materials, one or more conductive fillers/additives, and/or one or more binder materials. In some examples, the battery cells and/or electrodes are manufactured by immersing the current collector in molten metal (such as lithium or lithium alloy) or applying a slurry to coat the current collectors in a roll-to-roll manufacturing process. In some examples, the cathode current collectors 26 and/or the anode current collectors 46 comprise a foil layer.

In some examples, the current collectors are made of one or more materials selected from a group consisting of copper, stainless steel, brass, bronze, zinc, aluminum, and/or alloys thereof. In some examples, external tabs connected to the current collectors of the anode electrodes and cathode electrodes are located on opposite sides of the battery stack (as shown in FIG. 1) or on the same side of the battery stack as shown below.

Referring now to FIGS. 2A and 2B, a battery cell 58 includes an enclosure 60. In some examples, the enclosure 60 has rectangular cross-sections in x-, y- and z-axis planes. The enclosure 60 includes a can body 61 including sides 80 and sides 82 defining an open-ended rectangular prism or cube. In some examples, the sides 80 have a narrower width than the sides 82.

A lid portion 84 and a bottom portion 86 are attached to the can body 61 to enclose top and the bottom openings of the can body 61, respectively. The battery cell 58 includes external terminals 62 and 64 that pass through the lid portion 84. The stack 12 of the C cathode electrodes 20, the A anode electrodes 40, and the S separators 32 is arranged in the enclosure 60.

The external terminals 62 and 64 are connected to external tabs of the A anode electrodes 40 and the C cathode electrodes 20, respectively. In FIG. 2A, the lid portion 84 does not include a pressure-based vent cap. In FIG. 2B, the lid portion 84 (and/or the bottom portion 86) includes a pressure-based vent cap 66. The pressure-based vent cap 66 is configured to release vent gases when pressure within the inner enclosure is greater than a predetermined pressure.

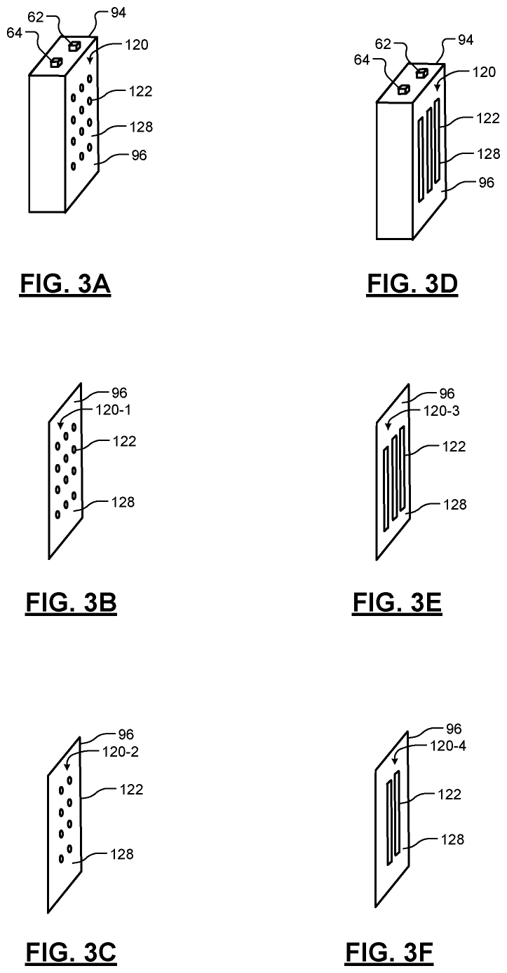

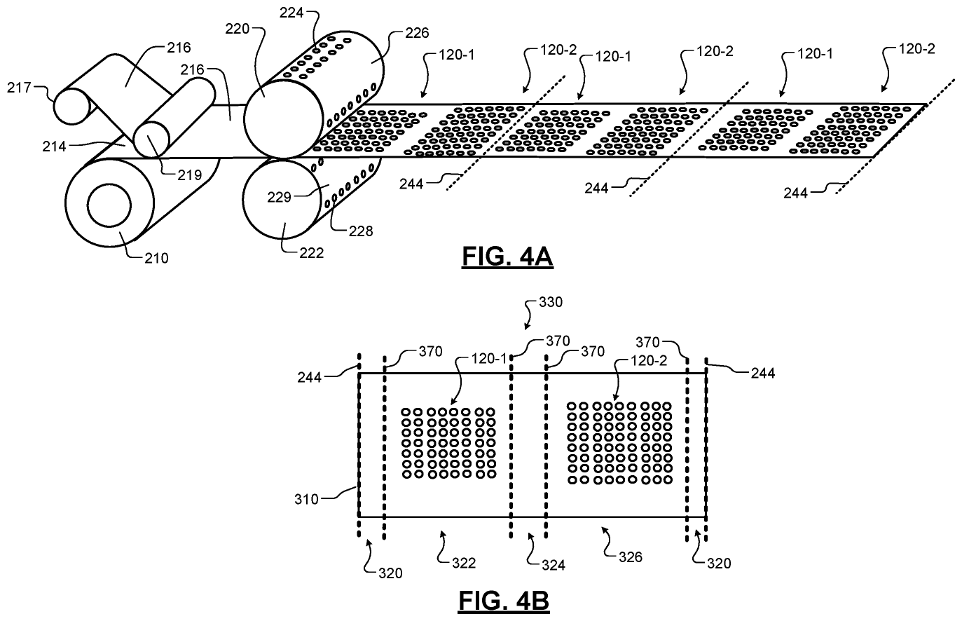

While the battery cells in FIGS. 2A and 2B are shown with a typical form factor, the manufacturing method according to the present disclosure can produce any form factor in the x-, y-, and z-axis planes. Alternately, a cylindrical battery cell format can be used. Referring now to FIGS. 3A to 3F, a battery cell 94 includes an enclosure 96 with one or more side surfaces 128 including a plurality of stiffening portions 122. While the stiffening portions 122 include dimples, the stiffening portions 122 can have different shapes such as beads or other shapes. In some examples, the dimples have a rectangular or hemispherical or arcuate shape.

In some examples, the stiffening portions 122 are arranged in a predetermined pattern 120 on the side surface 128 of the battery cell 94. In some examples, the stiffening portions 122 are arranged on surfaces of the enclosure 96 that have the largest area. In some examples, two or more side surfaces of the battery cell 94 have the same pattern of stiffening portions 122. In other examples, opposite side surfaces of the battery cell 94 have different patterns of the stiffening portions 122.

In FIG. 3A, the stiffening portions 122 include dimples that extend outwardly from the side surface 128 of the enclosure 96. In FIG. 3B, the stiffening portions 122 are arranged in a first predetermined pattern 120-1 on one of the side surfaces 128 of the enclosure 96. In FIG. 3C, the stiffening portions 122 are arranged in a second predetermined pattern 120-1 on an opposite one of the side surfaces 128 of the enclosure 96. In some examples, when two or more of the battery cells 94 are arranged adjacent to one another, the stiffening portions 122 of facing side surfaces of adjacent battery cells are offset to allow nesting. In some examples, a thermal insulating layer or a thermal interface material and a cooling plate are arranged between adjacent battery cells.

In FIGS. 3D to 3F, the stiffening portions 122 comprise stiffening beads or ribs having a rectangular cross section and that extend vertically or horizontally along one or more of the side surfaces. The stiffening portions 122 are arranged in a first predetermined pattern 120-3 on one side of the battery cell 94 and a second predetermined pattern 120-4 on an opposite side surface of the battery cell 94.

In some examples, the first predetermined pattern and the second predetermined pattern are the same. In other examples, the stiffening portions of the first predetermined pattern and the second predetermined pattern are different. For example, the stiffening portions on one side are complementary to allow nesting or overlapping to minimize space (e.g., offset relative to the stiffening portions on the opposite side). In other words, adjacent ones of the battery cells can be arranged in close proximity (e.g., with the stiffening portions in a nesting or interleaved pattern when aligned and/or positioned adjacent to one another).

In some examples, a backside volume created by the stiffening portions is filled with a material to provide a smooth surface. In some examples, the material comprises an insulating material or thermal interface material. In other examples, the material comprises a first suppressant material such as sodium bicarbonate.

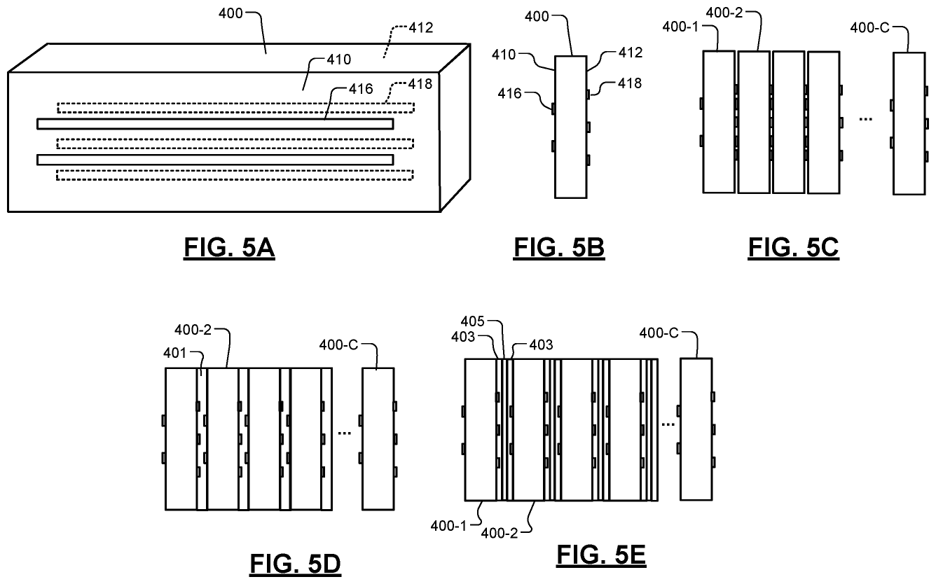

Referring now to FIGS. 4A and 4B, an example of manufacturing of the battery cell is shown. In FIG. 4A, a metal sheet 214 is pressed between the first roller 220 and the second roller 222. In some examples, the metal sheet 214 is made of steel having a thickness in a range from 0.1 mm to 0.5 mm. In some examples, the metal sheet 214 is made of steel having a thickness in a range from 0.2 mm to 0.3 mm.

In some examples, an insulating layer 216 is delivered by rollers 217 and 219 onto one or both surfaces of the metal sheet 214. In some examples, the insulating layer 216 comprises a polymer film such as polypropylene (PP) arranged on an inner surface of the enclosure to insulate the enclosure (rather than using an insulating layer around the battery stack). In other examples, the insulating layer comprises a coating that is sprayed onto the metal sheet 214.

The first roller 220 includes first and second sets of male projections 224 corresponding to locations of the stiffening portions of the first and second predetermined patterns. In some examples, the stiffening portions have a height in a range from 0.05 mm to less than 1 mm. Spaces 226 are located between the first and second sets of male projections 224.

The second roller 222 includes first and second sets of female cavities 228 that align with and correspond to locations of the first and second predetermined sets of male projections 224. Spaces 229 are located between the first and second sets of female cavities 228 (e.g., corresponding to areas without stiffening portions such as non-stressed sides of the enclosure). The first and second sets of male projections 224 bias the metal sheet 214 into the first and second sets of female cavities 228 to form the stiffening portions 240. After passing through the first roller 220 and the second roller 222. The metal sheet 214 is cut to length at 244.

As can be appreciated, the circumference of the first roller 220 and the second roller 222 can be equal to a length of a blank for the enclosure (or multiples thereof). The outer surface of the first roller 220 and the second roller 222 can include patterns for N of the enclosures, where N is an integer. In FIG. 4A, N=1. The circumference of the first roller 220 and the second roller 222 increases with N.

In FIG. 4B, a metal sheet 310 (e.g., cut from metal sheet 214) corresponding to an enclosure 330 for a battery cell is shown. The metal sheet 310 is shown with fold lines 370 to delineate sides 320, 322, 324, and 326 of the enclosure 330. During manufacturing, the metal sheet 310 is folded along the fold lines 370 and then welded to form a can body of the enclosure 330.

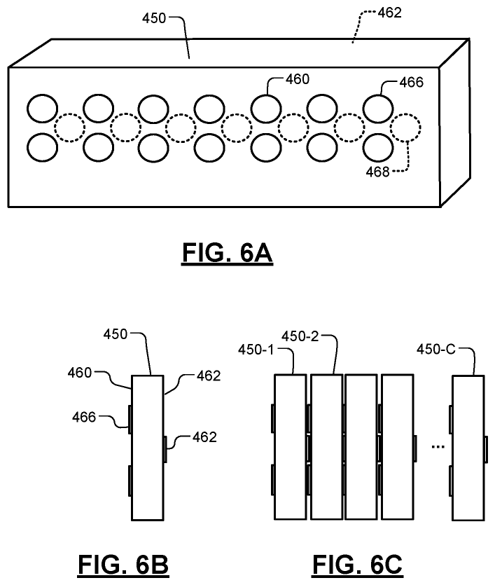

Referring now to FIGS. 5A to 5C, an example a battery cell 400 with stiffening beads 416 and 418 is shown. In FIGS. 5A and 5B, the stiffening beads 416 and 418 on opposite sides 410 and 412, respectively, are arranged offset from one another to allow nesting of stiffening beads of adjacent battery cells 400-1, 400-2, . . . , and 400-C shown in FIG. 5C, which reduces space.

In FIG. 5D, an insulating layer 401 is arranged between stressed sides of the adjacent battery cells. In some examples, the insulating layer 401 is compressed and deformed around the stiffening beads 416 and 418. In some examples, the insulating layer 401 has a thickness in a range from 2 mm to 5 mm. In some examples, the insulating layer 401 has a thickness in a range from 3 mm to 4 mm. In some examples, the insulating layer 401 comprises silica aerogel.

In FIG. 5E, a thermal interface material 403 is arranged on stressed sides of the adjacent battery cells and a cooling plate 405 is arranged between the thermal interface material 403. In some examples, the thermal interface material 403 is compressed and deformed around the stiffening beads 416 and 418. In some examples, the thermal interface material 403 has a thickness in a range from 0.5 mm to 1.5 mm (e.g., 1 mm).

Referring now to FIGS. 6A to 6C, an example a battery cell 450 with stiffening dimples 466 and 468 is shown. In FIGS. 6A and 6B, the stiffening dimples 466 and 468 on opposite sides 460 and 462, respectively, are arranged offset from one another to allow nesting of stiffening dimples of adjacent battery cells 450-1, 450-2, . . . , and 450-C shown in FIG. 6C, which reduces space. Thermal insulating layers or thermal interface material and cooling plates can be used (e.g., similar to FIGS. 5D and 5E).

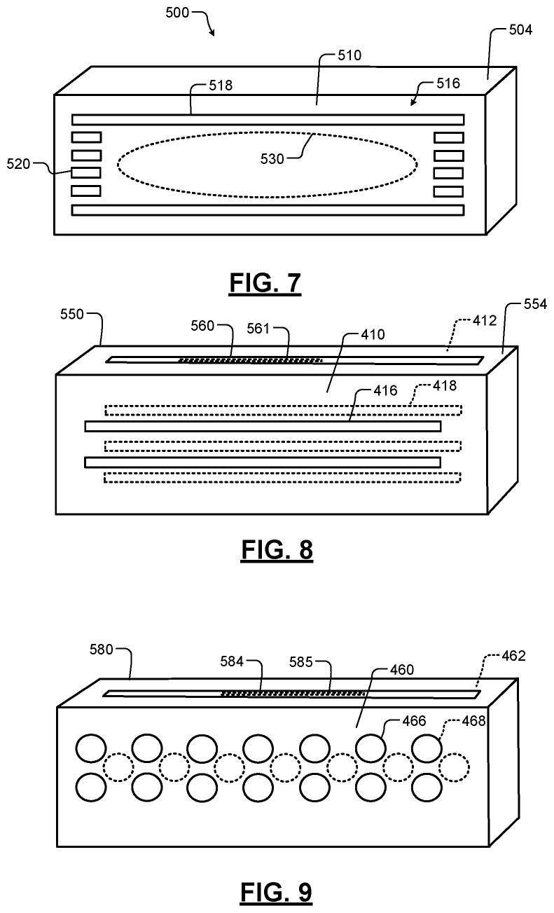

Referring now to FIG. 7, a battery cell 500 includes an enclosure 504 with one or more sides 510 including a first or peripheral region 516 and a second or central region 530 (e.g., arranged inside the peripheral region 516). The central region 530 of the side surface 510 of the battery enclosure is usually the hottest location when thermal runaway events occur. In some examples, stiffening portions are omitted in regions of the enclosure that tend to be hotter such as the central region 530 of the sides 510. Stiffening portions 518 and 520 are arranged in the peripheral region 516 (whereas the central region 530 does not include stiffening portions).

The battery enclosure in FIG. 7 helps to limit heat transfer or propagation between adjacent battery cells. There are no beads or dimples in the central region 530 where one or both of the adjacent battery cells are the hottest. In some examples, thermal insulating material or thermal interface material and a cooling plate (shown below) are arranged between the central regions 530 of the adjacent battery cells.

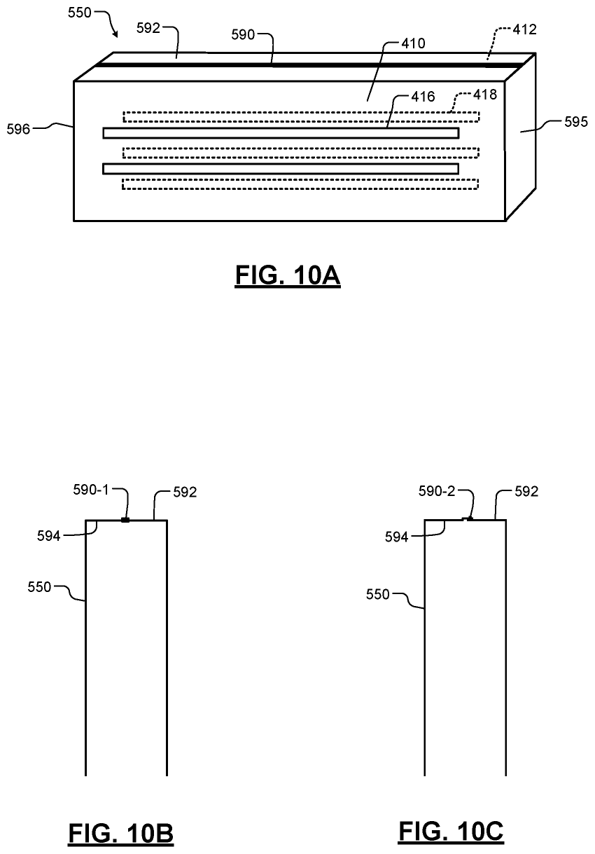

Referring now to FIGS. 8 and 9, examples of battery cells 550 and 580 are shown to include stiffening beads 560 and 584, respectively, on a non-stressed side surface. The stiffening beads 560 and 584 extend outwardly from the enclosure along the non-stressed surface of the battery cell. Volume created by the stiffening beads 560 and 584 can be used for devices 561 and 585, respectively. In some examples, devices 561 and 585 (such as a reference electrode, a thermocouple, a sensor, or other device) are arranged in a volume created by the stiffening beads 560 and 584. For example, the reference electrode provides a constant electrode reference that can be used to analyze potentials of the other electrodes in the battery cell. In some examples, the reference electrode comprises a silver (Ag)/silver chloride (AgCl) reference electrode.

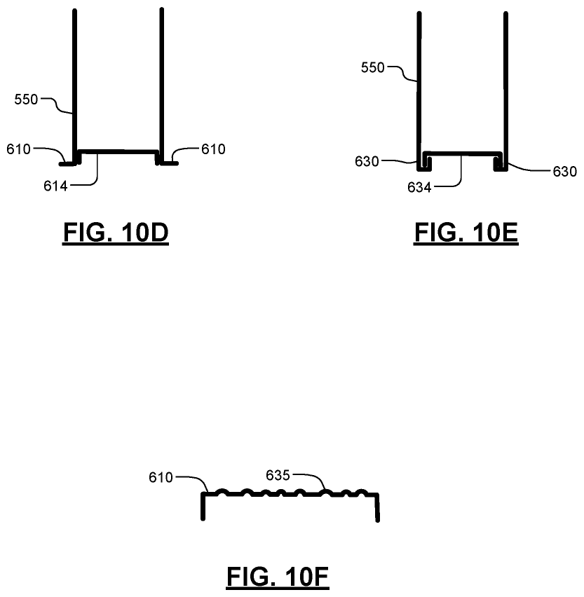

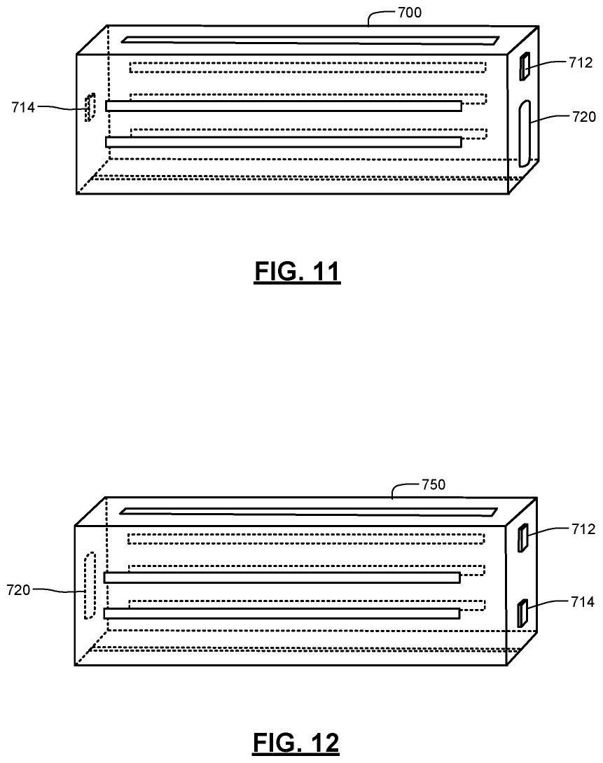

Referring now to FIGS. 10A to 10F, an enclosure for a battery cell is welded along one side (e.g., a non-stressed side such as a side opposite to the side including the stiffening beads 560 and/or 584). In FIG. 10A, a weld 590 joins opposite sides 592 and 594 together. In FIG. 10B, a weld 590-1 includes a butt joint. In FIG. 10C, a weld 590-2 includes a lap joint. In some examples, the weld 590 comprises a laser weld, although other types of welding can be used.

As a reference, an internal design pressure of an aerosol can is 1.7 MPa, which is less than 1.4 MPa corresponding to a maximum design pressure for battery cell enclosures. The aerosol can is made using steel that is 0.2 mm thick. The can body of the aerosol can is welded and the lid and/or bottom portions are mechanically joined (e.g., double seaming and/or crimping) to create a hermetically sealed enclosure.

In FIGS. 10D and 10E, the lid portion and/or the bottom portion of the enclosure can be mechanically joined. In FIG. 10D, a flange 610 having an “L”-shaped cross section is formed on ends of sides of the battery cells 550 of the enclosure using a fixture or other device. A cap 614 having a “C”-shaped cross section is mechanically joined to the flange 610 (e.g., from below). In FIG. 10E, a flange 630 having a “C”-shaped cross section is formed on ends of sides 550 of the enclosure using a fixture or other device. A cap 634 having a “C”-shaped cross section is mechanically joined to the flange (e.g., from above). In some examples, the caps 614 and 634 include micro dimples 635 as shown in FIG. 10F to increase cooling area.

Referring now to FIGS. 11 and 12, examples of locations of terminals and vents on the enclosure are shown. In FIG. 11, an enclosure 700 for a battery cell includes a vent 720 and terminals 712 and 714. The vent is arranged on the same side as the terminal 712. The terminals 712 and 714 are arranged on opposite sides.

The enclosure can have countercurrent terminals located on opposing sides of the can body (e.g., the lid portion and the bottom portion). Internally, the external tabs of the cathode electrodes and the anode electrodes face opposite directions. The vent can be located on either the lid portion and/or the bottom portion of the enclosure. Electrolyte can also be filled through the lid portion and/or the bottom portion. In some examples, the battery stack is inserted through the lid portion and the lid portion is sealed. Then the enclosure is inverted and electrolyte is filled through the bottom. The bottom is then sealed by welding (such as laser welding) or mechanical joining. Electrolyte can also be filled through a conventional electrolyte fill port which will be sealed with a vent cap (e.g., an aluminum (Al)/steel cap). The vent cap can be joined to the lid using laser brazing or welding.

In FIG. 12, an enclosure 750 for a battery cell includes a vent 720 and terminals 712 and 714. The vent 720 is arranged on the opposite side as the terminals 712 and 714. The terminals 712 and 714 are arranged on the same side. The enclosure has co-current terminals (e.g., terminals are located on the same side of the can (e.g., either the lid portion or the bottom portion). Internally, the external tabs of the cathode electrode and the anode electrode are on the same side. Note that the external tabs can still be located on opposite sides of the enclosure but the two terminals are on one side. In some examples, external tabs arranged on the bottom of the enclosure contact the enclosure (which is conductive) and one of the terminals is connected or shorted to the enclosure. The vent is located on the side opposite to the side including the terminals.

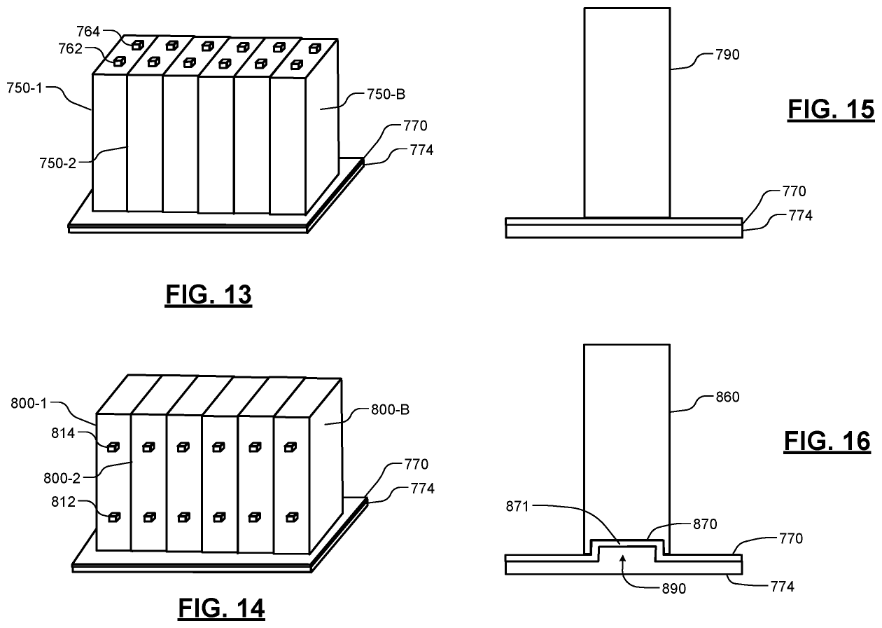

Referring now to FIGS. 13 and 14, examples of cooling plates are shown. In FIG. 13, a plurality of battery cells 750-1, 750-2, . . . , and 750-B are arranged on a thermal interface material 770 and a cooling plate 774 to cool bottom surfaces of the plurality of battery cells 750-1, 750-2, . . . , and 750-B. The plurality of battery cells 750-1, 750-2, . . . , and 750-B include terminals 762 and 764 on top surfaces of the plurality of battery cells 750-1, 750-2, . . . , and 750-B opposite to the bottom surfaces.

In FIG. 14, a plurality of battery cells 800-1, 800-2, . . . , and 800-B are arranged on the thermal interface material 770 and the cooling plate 774 to cool bottom surfaces of the plurality of battery cells 800-1, 800-2, . . . , and 800-B. The plurality of battery cells 800-1, 800-2, . . . , and 800-B include terminals 812 and 814 on side surfaces of the plurality of battery cells 800-1, 800-2, . . . , and 800-B adjacent to the bottom surfaces.

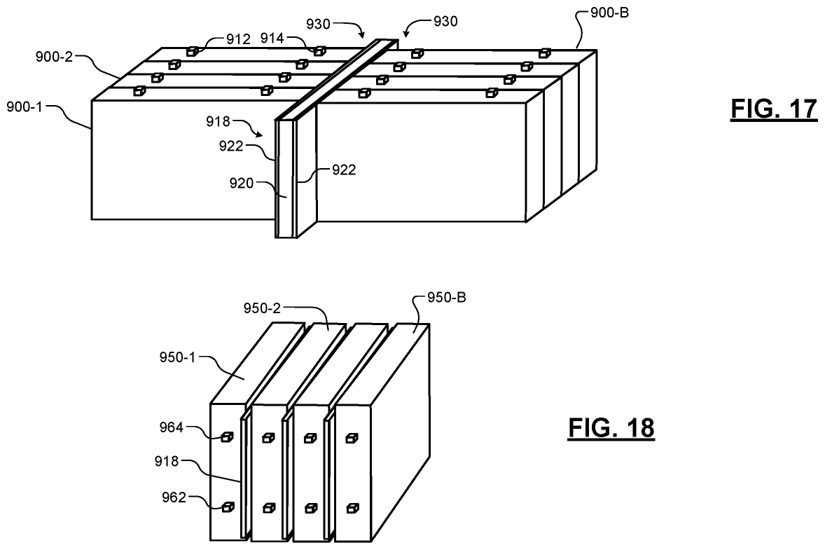

Referring now to FIGS. 15 and 16, examples of an interface between a bottom of an enclosure 790 of the battery cell and the thermal interface material 770 and the cooling plate 774 is shown. When the bottom of the enclosure 790 is flat, the thermal interface material 770 and the cooling plate 774 can be flat.

In FIG. 16, an enclosure 860 of a battery cell is not flat (e.g., mechanically joined) and forms a recess at 870. The thermal interface material 770 includes portions 871 that extend into the recesses 870 to maintain thermal communication. The cooling plate 774 includes a projection 890 extending into the portions 871 and/or into the recesses 870.

Referring now to FIGS. 17 and 18, other examples of cooling for a plurality of battery cells are shown. In FIG. 17, B battery cells 900-1, 900-2, . . . , and 900-B are arranged in an array including a plurality of rows and a plurality of columns. A cooling structure 918 including a cooling plate 920 sandwiched between thermal interface material 922 is arranged between adjacent ends 930 of the battery cells 900-1, 900-2, . . . , and 900-B located in adjacent columns. In this example, the terminals are arranged on a top surface of the battery cells 900-1, 900-2, . . . , and 900-B.

In FIG. 18, battery cells 950-1, 950-2, . . . , and 950-B are arranged adjacent to one another in a single row. The cooling structure 918 (e.g., including the cooling plate 920 sandwiched between thermal interface material 922) is arranged between sides of adjacent ones of the battery cells 900-1, 900-2, . . . , and 900-B. In some examples, the stiffening portions are arranged against the thermal interface material 922. In this example, the terminals are arranged on an end surface of the battery cells 900-1, 900-2, . . . , and 900-B.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

What is claimed is:

1. A battery cell comprising:
a can body of an enclosure comprising a sheet of metal that is folded and welded,
wherein the can body includes a first opening and a second opening at opposite ends of the can body, and
wherein the can body is configured to receive a battery cell stack;
a lid portion of the enclosure attached to the first opening of the can body; and
a bottom portion of the enclosure attached to the second opening of the can body.

2. The battery cell of claim 1, wherein the battery cell stack includes:
A anode electrodes;
C cathode electrodes; and
S separators, where A, C, and S are integers greater than one.

3. The battery cell of claim 1, wherein a first side of the enclosure includes a plurality of stiffening portions arranged in a first pattern.

4. The battery cell of claim 3, wherein:
a second side of the enclosure opposite to the first side of the enclosure includes a plurality of stiffening portions arranged in a second pattern, and
the first pattern and the second pattern are different.

5. The battery cell of claim 4, wherein the first pattern and the second pattern are offset to allow nesting of the battery cell with one or more adjacent battery cells.

6. The battery cell of claim 3, wherein the plurality of stiffening portions comprise at least one of dimples and stiffening beads.

7. The battery cell of claim 6, wherein the dimples have one of a rectangular cross section and an arcuate cross section.

8. The battery cell of claim 2, wherein:
one of the lid portion and the bottom portion includes a first terminal and a second terminal connected to external tabs of the A anode electrodes and the C cathode electrodes, respectively; and
at least one of the lid portion and the bottom portion includes a vent.

9. The battery cell of claim 2, wherein:
the lid portion includes a first terminal connected to external tabs of the A anode electrodes;
the bottom portion includes a second terminal connected to external tabs of the C cathode electrodes; and
at least one of the lid portion and the bottom portion includes a vent.

10. The battery cell of claim 1, wherein a side of the enclosure includes a stiffening bead extending outwardly therefrom and a measuring device arranged in a volume created by the stiffening bead.

11. The battery cell of claim 3, wherein:
the first pattern includes a first region and a second region; and
the plurality of stiffening portions are arranged in the first region and not in the second region, wherein the second region is hotter than the first region during a battery thermal event.

12. The battery cell of claim 1, wherein:
edges of the sheet of metal are welded together along a non-stressed side of the can body,
the bottom portion is attached to the can body using one of welding and mechanical joining, and
the lid portion is attached to the can body using one of welding and mechanical joining.

13. The battery cell of claim 1, wherein at least one of the bottom portion and the lid portion include micro dimples.

14. The battery cell of claim 3, wherein a volume created by the plurality of stiffening portions is filled with a one of an insulating material and a thermal interface material.

15. A system comprising:
a plurality of the battery cells of claim 1;
a cooling plate;
a thermal interface material arranged between the cooling plate and a first one of the plurality of the battery cells and a second one of the plurality of the battery cells.

16. A system comprising:
a plurality of the battery cells of claim 1;
an insulating material arranged between adjacent ones of the plurality of the battery cells.

17. A method for manufacturing a battery cell, comprising:
using first and second rollers to create a first pattern of stiffening portions and a second pattern of stiffening portions on a sheet of metal;
folding the sheet of metal into an open cylindrical shape to form a can body of an enclosure,
wherein the first pattern of stiffening portions is located on one side of the enclosure and the second pattern of stiffening portions is located on another side of the enclosure;
welding a non-stressed side of the enclosure;
attaching a lid portion to a first opening of the can body; and
attaching a bottom portion to a second opening of the can body.

18. The method of claim 17, wherein:
the first pattern of stiffening portions comprise at least one of dimples and stiffening beads;
the first pattern of stiffening portions and the second pattern of stiffening portions are different; and
the first pattern of stiffening portions and the second pattern of stiffening portions are offset to allow nesting of the battery cell with one or more adjacent battery cells.

19. The method of claim 17, further comprising:
attaching the lid portion to the first opening of the enclosure using at least one of mechanical joining and welding; and
attaching the bottom portion to the second opening of the enclosure using at least one of mechanical joining and welding.

20. The method of claim 17, wherein one of:
one of the lid portion and the bottom portion includes a first terminal and a second terminal connected to external tabs of A anode electrodes and C cathode electrodes of a battery stack, respectively and at least one of the lid portion and the bottom portion includes a vent; or
the lid portion includes a first terminal connected to external tabs of one of the A anode electrodes and the C cathode electrodes, the bottom portion includes a second terminal connected to external tabs of the other of the A anode electrodes and the C cathode electrodes, and at least one of the lid portion and the bottom portion includes a vent.
